(19) United States
(12) Patent Application Publication
(10) Pub. No.: US 2010/0009057 A1
(43) Pub. Date: Jan. 14, 2010

(54) TEQUILA BASED DRINK PREPARATIONS

(76) Inventor: Kemp SIMONETTO, Chicago, IL (US)

Correspondence Address: BERENATO & WHITE, LLC, 6550 ROCK SPRING DRIVE, SUITE 240, BETHESDA, MD, 20817, US

(21) Appl. No.: 12/499,274

(22) Filed: Jul. 8, 2009

Related U.S. Application Data
(60) Provisional application No. 61/080,412, filed on Jul. 14, 2008.

(51) Int. Cl. C12G 3/06

(52) U.S. Cl. 426/592

(57) ABSTRACT

The present consumable beverage relates to two separate tequila based mixtures: 1) pepper juice or combination of pepper juices and tequila relative to the percentage of blue agave and the age of the tequila; 2) fruit juice or combination of fruit juices and tequila relative to the percentage of blue agave and the age of the tequila. The respective mixtures create a multitude of new varieties of tequila based drinks that are unique, diverse, have distinct tastes, flavors, and palates, and include new colors and bouquets. Furthermore, by adjusting the proportions of pepper/fruit juice or combination of pepper/fruit juices and tequila relative to the percentage of blue agave and the age of the tequila, specific tastes, flavors, and palates can be accentuated and emphasized in each unique mixture

This application claims the benefit of prior filed U.S. provisional application Ser. No. 61/080,412, filed Jul. 14, 2008.

### BACKGROUND OF THE INVENTION

1. Field of the Invention

The invention relates generally to: two separate tequila based mixtures: 1) pepper juice or combination(s) of pepper juices and tequila relative to the percentage of blue agave and the age of the tequila; 2) fruit juice or combination(s) of fruit juices and tequila relative to the percentage of blue agave and the age of the tequila.

2. Background

Cocktail and drink mixtures have been in existence as long as alcohol based beverages have existed. Many were developed during Prohibition to mask the taste of poorer quality alcohol, but have persisted and expanded since that time. All manner of special concoctions exist and come from all points of the compass, culture, and lifestyle. The preparations range from lethal, i.e., grain alcohol or moonshine, to bar served mixtures, to medicinal preparations handed down generation to generation. Examples of known drink combinations include U.S. Pat. Nos. 3,647,472; 4,738,857; 4,790,999; US 2002/0122861 A1; and, U.S. Pat. No. 4,946,701. Despite the apparent variety, however, boredom can ensue where insufficient experimentation has not been done, or where market pressure has created a common palate for all alcohol specific type beverages. For example, all gin based beverages, all bourbon based, etc. The distinctions, if any, are only available in the small batch or limited quantity specialty distillations, i.e., single malt scotches, single barrel bourbons, etc. The mass produced blended varieties become, with time and widespread consumption, too similar and bland. Tequila based beverages also fall into this category.

The current state of technology for tequila has fostered the reproduction of the same relative tastes, flavors and palates amongst the hundreds of similar tequila products. The reason for so many similar or common tequila products is two tiered. First, all tequila alcohol falls under one of two categories: 1) tequila made from 100% blue agave or, 2) tequila made from a minimum of 51% blue agave. Second, all tequila alcohol falls under one of the “five types” of tequila based on “aging”, please note, only types #3, #4, and #5 are actually aged:
1) Blanco/Plata or White/Silver, which is a clear spirit, un-aged, bottled almost immediately after distillation.
2) Oro/Gold, which is Blanco or White tequila with additional ingredients like caramel coloring, almond syrup, glycerine, oak extracts, etc, that is mixed with Aged or Rested tequilas to make it resemble or appear to be “Aged” tequila.
3) Reposado or Rested tequila, which is aged a minimum of two months but less than a year in oak barrels.
4) Anejo or Aged tequila, which is aged a minimum of one year but less than three years in oak barrels, to include Reserva or Reserved tequila, which is Anejo or Aged tequila that is aged up to eight years in oak barrels.
5) Extra Anejo or Extra/Ultra Aged tequila, which is aged a minimum of three years in oak barrels.

It is this current “state of technology” for tequila which fosters the reproduction of the same relative tastes, flavors and palates resulting in very little distinction, even less diversity, and almost no variety.

### SUMMARY OF THE INVENTION

The present invention advantageously fills the aforementioned deficiencies by providing a mixture of pepper or fruit juice(s) or combinations of pepper or fruit juices and tequila alcohol relative to the percentage of blue agave and the age of the tequila. The mixture(s) of pepper/fruit juice(s) or combination of pepper/fruit juices and tequila relative to the percentage of blue agave and the age of the tequila creates a plethora of new varieties as well as a multitude of new, unique, diverse, and distinct tastes, flavors, palates, colors, and bouquets.

One such mixture already researched that demonstrates my invention in terms of a new, unique, diverse, yet distinct taste, flavor, and palate is the mixture of: sweet pepper juice, a hint of tabasco pepper juice, and, tequila made from 51% blue agave and aged two years in an oak barrel. The example illustrates a new, unique, and distinct taste, flavor and palate created through mixture of pepper juice or combination of pepper juices and tequila relative to the percentage of blue agave and the age of the tequila.

The pepper juice version of the invention is comprised of two parts:

Part (1 ) is the pepper juice or combination of pepper juices. The peppers used to create the pepper juices are primarily from the genus Capsicum, species Annuum, Chinense, Baccatum, Frutescens, Pubescens, genus Piper, species Aduncum, Auritum, Betel, Cubeba, Guineense, Kadsura, Longum, Methyysticum, Nigrum, Saigonense, Sarmentosum, Sylvaticum, among others.

The fruit juice version of the invention likewise is comprised of two parts:

The following is a list of the Family and Genus of those fruits, among others, used to make the fruit juices of Part (1).

| Family | Genus |
|---|---|
| Rosaceae | Prunus, Malus, Pyrus, Fragaria |
| Rutaceae | Citrus, Chinense |
| Moraceae | Ficas, Morus, Artocarpus |
| Grossulariaceae | Ribes |
| Cactaceae | Opuntia, Hylocereus, Selenicereus |
| Ericaceae | Vaccinium |
| Anacardiaceae | Mangifera, Spondias |
| Sapindales | Nephelium, Litchi |
| Caricaceae | Carica |
| Passifloraceae | Passiflora |
| Oxalidaceae | Averrhoa |
| Annonaceae | Annona |
| Cucurbitaceae | Citrullus, Cucumis |
| Oleaceae | Olea |
| Musaceae | Musa |
| Bromeliaceae | Ananas |
| Myrtaceae | Psidium |
| Vitaceae | Vitis |
| Lythraceae | Punica |
| Actinidiaceae | Actinidia |
| Clusiaceae | Garcinia |
| Malavaceae | Duria |

Part (2) of either the pepper juice or fruit juice version of the invention is the tequila alcohol. The tequila alcohols included in the invention is based on the percentage of blue agave included. Those tequila's made from at least 51% blue agave to those tequilas made from 100% blue agave are included. The tequila alcohols included in the invention based on the age of the tequila include: Blanco/Plata or White/Silver, which is a clear spirit, un-aged, bottled almost immediately after distillation; Oro/Gold, which is Blanco or White tequila with additional ingredients like caramel coloring, almond syrup, glycerine, oak extracts, etc, that is mixed with Aged or Rested tequilas to make it resemble or appear to be “Aged” tequila; Reposado or Rested tequila, which is aged a minimum of two months but less than a year in oak barrels; Anejo or Aged tequila, which is aged a minimum of one year but less than three years in oak barrels; Reserva or Reserved tequila, which is Anejo or Aged tequila that is aged up to eight years in oak barrels; and, lastly, Extra Anejo or Extra/Ultra Aged tequila, which is aged a minimum of three years in oak barrels. Also included are those tequilas aged up to and beyond 8 years.

Part (2) also optionally includes the use of Mezcal. Mezcal is not considered tequila because it is made from different types of agave other than the blue agave and uses different sugars in the fermentation process. In the context of this invention, however, Mezcal will be used as an alternative to or in conjunction with the tequila to expand upon the diversity and distinctiveness in variety as well as taste, flavor, and palate.

My invention establishes parameters within which those flexible proportions operate to achieve the goals of my invention. The basic parameters are:
The minimum proportion of pepper juice or combination of pepper juices (likewise for fruit juice or a combination of fruit juices) and tequila relative to the percentage of blue agave and the age of the tequila is a (½) a teaspoon of pepper juice/fruit juice per (1) ounce of tequila.
The maximum proportion of pepper juice or combination of pepper juices (likewise for fruit juices or a combination of fruit juices) and tequila relative to the percentage of blue agave and the age of the tequila is (2.0) ounces of pepper juice/fruit juice per (1) ounce of tequila.

The proportions, a (½) teaspoon to (2) ounces of pepper juice/fruit juice per (1) ounce of tequila, in each unique mixture of pepper juice or combination of pepper juices fruit juice or combination of fruit juices and tequila relative to the percentage of blue agave and the age of the tequila are determined by the type of pepper juice/fruit juice, combination of pepper juices/fruit juices, percentage of blue agave in the tequila, and the age of the tequila.

Finally, it is an object of the present invention to provide a mixture of pepper juice or combination of pepper juices (or fruit juice or a combination of fruit juices) and tequila alcohol relative to the percentage of blue agave and the age of the tequila that does not suffer from any of the problems or deficiencies associated with prior solutions.

The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 is an illustration of the overall invention of the mixture of tequila and pepper juice.

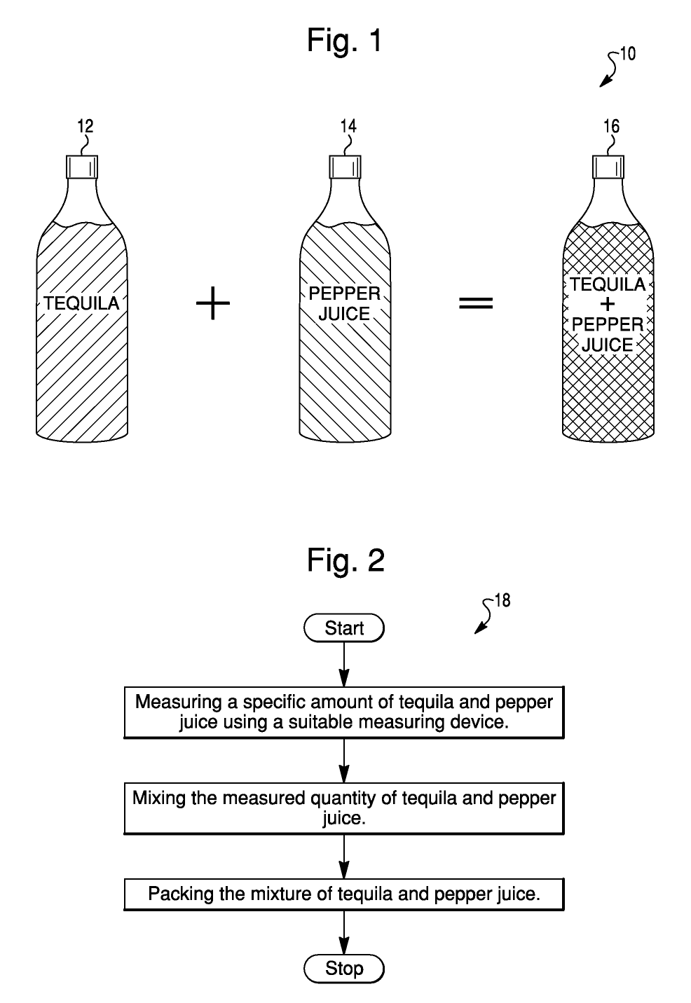

FIG. 2 is a flow chart depicting the steps of the invention.

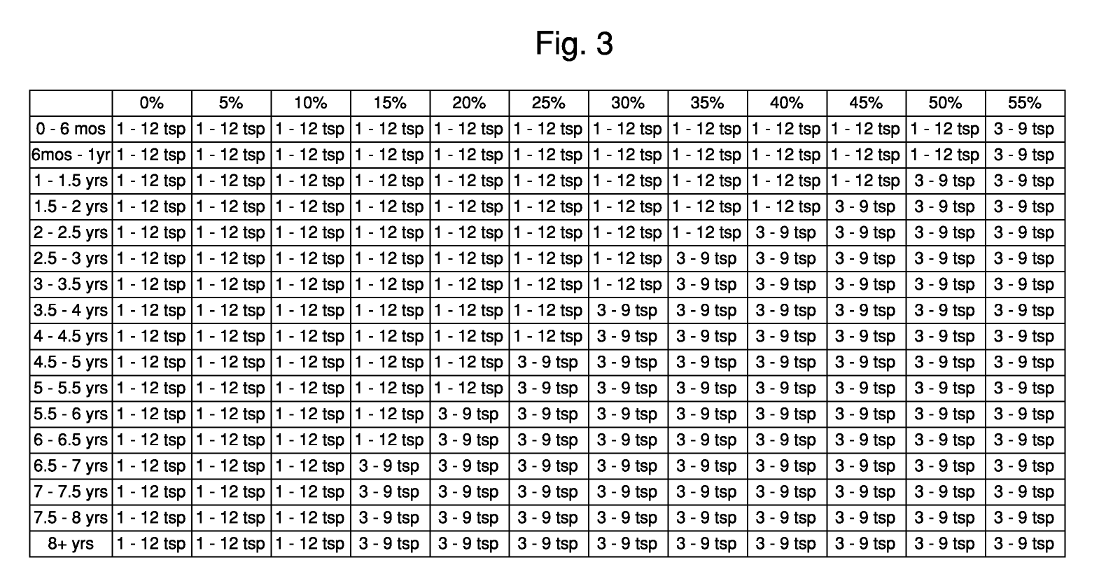

FIG. 3 includes Table 1 from which the relative proportions of mixtures of tequila and pepper juice or tequila and fruit juice are obtained based on Vertical Axis Age of Tequila, Hoizontal Axis, percentage of Blue Agave in the Tequila being used.

### DETAILED DESCRIPTION OF THE INVENTION

The present invention is the mixture of pepper juice or combination of pepper juices (or fruit juice or a combination of fruit juices) and tequila alcohol relative to the percentage of blue agave and the age of the tequila.

The invention comprises two parts. Part (1) is the pepper juice/fruit juice and tequila. Part (2) is the mixture of the pepper juice or pepper juices fruit juice or fruit juices and tequila alcohol using flexible proportions that are determined by the type of pepper juice, combination of pepper juices, percentage of blue agave in the tequila, and the age of the tequila.

### Part (1), Pepper Juice:

The first element in the invention is the types of peppers used to create the pepper juice or combination of pepper juices. The peppers used to make the pepper juices are primarily from the genus Capsicum, species Annuum, Chinense, Baccatum, Frutescens, Pubescens, genus Piper, species Aduncum, Auritum, Betel, Cubeba, Guineense, Kadsura, Longum, Methyysticum, Nigrum, Saigonense, Sarmentosum, and Sylvaticum, among others.

### Part (1), Fruit Juice:

The following is a list of the Family and Genus of those fruits, among others, used to make the fruit juices of Part (1).

| Family | Genus |
|---|---|
| Rosaceae | Prunus, Malus, Pyrus, Fragaria |
| Rutaceae | Citrus, Chinense |
| Moraceae | Ficas, Morus, Artocarpus |
| Grossulariaceae | Ribes |
| Cactaceae | Opuntia, Hylocereus, Selenicereus |
| Ericaceae | Vaccinium |
| Anacardiaceae | Mangifera, Spondias |
| Sapindales | Nephelium, Litchi |
| Caricaceae | Carica |
| Passifloraceae | Passiflora |
| Oxalidaceae | Averrhoa |
| Annonaceae | Annona |
| Cucurbitaceae | Citrullus, Cucumis |
| Oleaceae | Olea |
| Musaceae | Musa |
| Bromeliaceae | Ananas |
| Myrtaceae | Psidium |
| Vitaceae | Vitis |
| Lythraceae | Punica |
| Actinidiaceae | Actinidia |
| Clusiaceae | Garcinia |
| Malavaceae | Duria |

The second element, Part (2), of the invention is the tequila or Mezcal. The percentage of blue agave is a factor and includes those tequila's made from at least 51% blue agave to those tequila's made from 100% blue agave. The age of the tequila is a factor and includes those tequila's like Blanco/Plata or White/Silver tequila; Oro/Gold tequila, Reposado or Rested tequila; Anejo or Aged tequila; Reserva or Reserved tequila; and, Extra Anejo or Extra/Ultra Aged tequila.

The mixture of the pepper juice or pepper juices (or fruit and fruit juices) and tequila alcohol uses flexible proportions as determined by the type of pepper juice, combination of pepper juices, fruit juice, combination of fruit juices percentage of blue agave in the tequila, and the age of the tequila.

The mixture of pepper juice or combination of pepper juices and tequila relative to the percentage of blue agave and the age of the tequila will occur either before, during, or after the aging process of the tequila. This is due to the fact that when the elements are combined directly effects the taste, flavor and palate in each unique mixture.

The minimum proportion of pepper juice or combination of pepper juices (or fruit juice or a combination of fruit juices) and tequila relative to the percentage of blue agave and the age of the tequila is (½) a teaspoon of pepper juice/fruit juice per (1) ounce of tequila. The maximum proportion of pepper juice or combination of pepper juices (or fruit juice or a combination of fruit juices) and tequila relative to the percentage of blue agave and the age of the tequila is (2.0) ounces of pepper juice/fruit juice per (1) ounce of tequila.

The flexibility in the proportions, i.e. (½) teaspoon to (2.0) ounces of pepper juice/fruit juice per (1) ounce of tequila, allows for and enables the creation and accentuation of specific tastes, flavors and palates in each unique mixture and is determined by the type of pepper juice, combination of pepper juices, fruit juice, combination of fruit juices, percentage of blue agave in the tequila, and the age of tequila on a mixture by mixture basis.

One such mixture already mentioned will illustrate the mixture of the stated elements based on the flexible proportions as determined by the type of pepper juice, combination of pepper juices, percentage of blue agave, and the age of the tequila.

The previous example used was the mixture of sweet pepper juice, tabasco pepper juice, tequila made from 51% blue agave, aged two years in an oak barrel. Each element brings a unique taste and flavor. The dominance of the sweet peeper juice is underscored by a subtle yet sharp hint of tabasco pepper juice all of which is contrasted by the smooth yet edgy taste and palate of tequila made with minimum of 51% blue agave and aged two years in an oak barrel. Proportionally, that would be (1) tablespoon of sweet pepper juice; (1) teaspoon of tabasco pepper juice per (1.0) ounces of tequila made from 51% blue agave and aged two years in an oak barrel.

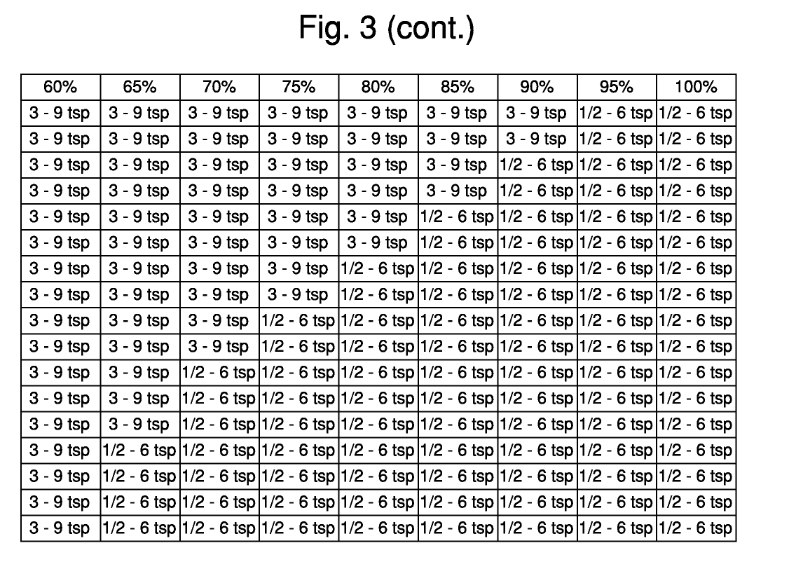

Table 1, shown as FIG. 3, includes a matrix of combinations of the invention drink preparation. The Table enables a user to, by age of the Tequila, select an individual horizontal mixture listing. Then, by relying on the percentage Blue Agave along the top register of the Table, and aligning with the horizontal mixture listing, a particular combination of pepper or fruits juices can be determined. Each mixture is based on a single liquid ounce (approximately a shot glass) of Tequila/Mezcal.

For Table 1:

1) Across the top of the matrix is the percentage of blue agave starting at 0% and ending at 100%. Please note, 0% blue agave to 49% blue agave is Mezcal, 51% blue agave to 100% blue agave is tequila.

2) On the left hand side of the matrix is the age of the tequila/mezcal in 6 month intervals starting at 0 to 6 months and ending at 8 plus years.

3) Each square in the matrix is an individual mixture.

4) Each mixture has a range listed within it identifying the minimum number to maximum number of teaspoons of pepper juice, combination of pepper juices, fruit juice, or combination of fruit juices per (1) ounce of tequila, as it relates to the age of the tequila and percentage of blue agave.

The examples illustrate not only the creation of a new, unique and distinct variety of tequila achieved through the dominance of the sweet pepper juice over other pepper/fruit juices, but a new, unique and distinct taste, flavor and palate based on the contrast created between the sweet pepper juice, hint of tabasco pepper juice, percentage of blue agave, and age of the tequila. New, unique and distinct creations such as this are only created through the mixture of pepper juice or combination of pepper/fruit juices and tequila relative to the percentage of blue agave and the age of the tequila using flexible proportions.

While the present invention has been described above in terms of specific embodiments, it is to be understood that the invention is not limited to these disclosed embodiments. Many modifications and other embodiments of the invention will come to mind of those skilled in the art to which this invention pertains, and which are intended to be and are covered by both this disclosure and the appended claims It is indeed intended that the scope of the invention should be determined by proper interpretation and construction of the appended claims and their legal equivalents, as understood by those of skill in the art relying upon the disclosure in this specification and the attached drawings.

1. A tequila based drink preparation, comprising:
a combination of pepper juice and tequila, wherein said pepper juice is provided in an amount of ½-12 teaspoons for every 1 liquid ounce of tequila, an amount of said pepper juice being determined in accord with the age of said tequila and the percentage of Blue Agave in said tequila in accord with Table 1.

2. A tequila based drink preparation as in claim 1, wherein:
1-12 teaspoons of pepper juice is used in combination with 1 liquid ounce of tequila wherein said tequila is between the ages of 0-8 years and has a blue agave content of 0-10%.

3. A tequila based drink preparation as in claim 1, wherein:
3-9 teaspoons of pepper juice is used in combination with 1 liquid ounce of tequila wherein said tequila is between the ages of 0-8 years and has a blue agave content of 15-50%.

4. A tequila based drink preparation as in claim 1, wherein:
3-9 teaspoons of pepper juice is used in combination with 1 liquid ounce of tequila wherein said tequila is between the ages of 0-8 years and has a blue agave content of 55-90%.

5. A tequila based drink preparation as in claim 1, wherein:
½-6 teaspoons of pepper juice is used in combination with 1 liquid ounce of tequila wherein said tequila is between the ages of 0-8 years and has a blue agave content of 95-100%.

6. A tequila based drink preparation as in claim 1, wherein:
1-12 teaspoons of pepper juice is used in combination with 1 liquid ounce of tequila wherein said tequila is aged more than 8 years and has a blue agave content of 0-10%.

7. A tequila based drink preparation as in claim 1, wherein:
3-9 teaspoons of pepper juice is used in combination with 1 liquid ounce of tequila wherein said tequila is aged more than 8 years and has a blue agave content of 15-60%.

8. A tequila based drink preparation as in claim 1, wherein:
½-6 teaspoons of pepper juice is used in combination with 1 liquid ounce of tequila wherein said tequila is aged more than 8 years and has a blue agave content of 65-100%.

9. A tequila based drink preparation, comprising:
a combination of fruit juice and tequila, wherein said juice is provided in an amount of ½-12 teaspoons for every 1 liquid ounce of tequila, an amount of said juice being determined in accord with the age of said tequila and the percentage of Blue Agave contained in said mixture as in Table 1.

10. A tequila based drink preparation as in claim 9, comprising:
1-12 teaspoons of fruit juice is used in combination with 1 liquid ounce of tequila wherein said tequila is between the ages of 0-8 years and has a blue agave content of 0-10%.

11. A tequila based drink preparation as in claim 9, wherein:
3-9 teaspoons of fruit juice is used in combination with 1 liquid ounce of tequila wherein said tequila is between the ages of 0-8 years and has a blue agave content of 15-50%.

12. A tequila based drink preparation as in claim 9, wherein:
3-9 teaspoons of fruit juice is used in combination with 1 liquid ounce of tequila wherein said tequila is between the ages of 0-8 years and has a blue agave content of 55-90%.

13. A tequila based drink preparation as in claim 9, wherein:
½-6 teaspoons of fruit juice is used in combination with 1 liquid ounce of tequila wherein said tequila is between the ages of 0-8 years and has a blue agave content of 95-100%.

14. A tequila based drink preparation as in claim 9, comprising:
1-12 teaspoons of fruit juice is used in combination with 1 liquid ounce of tequila wherein said tequila is aged more than 8 years and has a blue agave content of 0-10%.

15. A tequila based drink preparation as in claim 9, wherein:
3-9 teaspoons of fruit juice is used in combination with 1 liquid ounce of tequila wherein said tequila is aged more than 8 years and has a blue agave content of 15-60%.

16. A tequila based drink preparation as in claim 9, wherein:
½-6 teaspoons of fruit juice is used in combination with 1 liquid ounce of tequila wherein said tequila is aged more than 8 years and has a blue agave content of 65-100%.
